(19) United States
(12) Patent Application Publication
(10) Pub. No.: US 2016/0105285 A1
(43) Pub. Date: Apr. 14, 2016

(54) DERIVING CRYPTOGRAPHIC KEYS FROM BIOMETRIC PARAMETERS

(71) Applicant: QUALCOMM Incorporated, San Diego, CA (US)

(72) Inventor: Bjorn Markus Jakobsson, Portola Valley, CA (US)

(21) Appl. No.: 14/514,312

(22) Filed: Oct. 14, 2014

(51) Int. Cl. H04L 9/32; H04L 9/14

(52) U.S. Cl. CPC H04L 9/3231; H04L 9/14; H04L 2209/24

(57) ABSTRACT

One feature pertains to a biometric cryptographic technique that exploits synthetic fingerprints or other synthetic biometric information. In one aspect, biometric parameters are obtained from a user and compared to a database of biometric templates to identify templates that most closely match the biometric parameters of the user. The database includes several authentic templates for the user and a much larger number of templates derived from synthetic biometric information (e.g. a million or more synthetic templates) not associated with the user. A set of candidate cryptographic keys are obtained based on the templates that most closely match the biometric parameters from the user. The candidate cryptographic keys are applied to access information secured with a valid cryptographic key of the user to identify a key that gains access, thus decrypting data and authenticating the user. In addition to decryption and authentication, digital signatures can be obtained using techniques described herein.

### BACKGROUND

1. Field

Various features relate to deriving cryptographic keys from biometric parameters for accessing encrypted information or for biometric user authentication.

2. Background

Biometric authentication procedures such as Fast IDentity Online (FIDO) procedures typically involve: performing a biometric reading; comparing the result to a template; and indicating authentication if there is a sufficiently accurate match. The comparison is not “verbatim.” For example, for a biometric fingerprint, the finger may be pressed too hard so that some minutia cannot be read, or not pressed hard enough, etc. The matching algorithm must find an approximate fit according to some closeness measure. In contrast, cryptographic keys are generally either correct or not and hence cannot be derived easily from biometrics. Hence, there is strong demand for a solution to the problem of effectively deriving cryptographic keys from biometric readings to, e.g., authenticate a user or to decrypt user data without relying on keys created by the user, which may have insufficient entropy. As such, it would be desirable to provide a reliable technique to map “fuzzy” biometric sensor readings to cryptographic keys. In this regard, there are existing “fuzzy” hash algorithms that attempt to produce fixed outputs from slightly variable inputs. However, such algorithms are not typically suitable for mapping from two-dimensional spaces (such as fingerprints or iris scans), nor are they generally suitable for biometric authentication and decryption methods.

Hence, there is a need to provide reliable and effective techniques for deriving cryptographic keys from biometric parameters for biometric user authentication, decryption of user information, or for other purposes.

### SUMMARY

A method for biometric processing includes: obtaining biometric parameters from a user; comparing the biometric parameters to a database of biometric data objects to identify biometric data objects that most closely match the biometric parameters from the user, wherein the database includes at least one authentic biometric data object for the user and a larger number of synthetic biometric data objects not associated with the user; obtaining a plurality of candidate cryptographic keys based on the biometric data objects that most closely match the biometric parameters from the user; and applying one or more of the plurality of candidate cryptographic keys in an attempt to access information secured with a valid cryptographic key of the user.

In another aspect, a device includes: a biometric parameter detector operative to obtain at least one biometric parameter from a user; a storage device; and a processing circuit operative to obtain biometric parameters from the user using the biometric parameter detector; compare the biometric parameters to a database of biometric data objects stored in the storage device to identify biometric data objects that most closely match the biometric parameters from the user, wherein the database includes at least one authentic biometric data object for the user and a larger number of synthetic biometric data objects not associated with the user; obtain a plurality of candidate cryptographic keys based on the biometric data objects that most closely match the biometric parameters from the user; and apply one or more of the plurality of candidate cryptographic keys in an attempt to access information secured with a valid cryptographic key of the user.

In yet another aspect, a device includes: means for obtaining biometric parameters from the user; means for comparing the biometric parameters to a database of biometric data objects to identify biometric data objects that most closely match the biometric parameters from the user, wherein the database includes at least one authentic biometric data object for the user and a larger number of synthetic biometric data objects not associated with the user; means for obtaining a plurality of candidate cryptographic keys based on the biometric data objects that most closely match the biometric parameters from the user; and means for applying one or more of the plurality of candidate cryptographic keys in an attempt to access information secured with a valid cryptographic key of the user.

In still yet another aspect, a machine-readable storage medium for biometric processing includes one or more instructions which when executed by at least one processing circuit causes the at least one processing circuit to: obtain biometric parameters from the user; compare the biometric parameters to a database of biometric data objects to identify biometric data objects that most closely match the biometric parameters from the user, wherein the database includes at least one authentic biometric data object for the user and a larger number of synthetic biometric data objects not associated with the user; obtain a plurality of candidate cryptographic keys based on the biometric data objects that most closely match the biometric parameters from the user; and apply one or more of the plurality of candidate cryptographic keys in an attempt to access information secured with a valid cryptographic key of the user.

### BRIEF DESCRIPTION OF THE DRAWINGS

FIG. 1 provides a broad overview of an exemplary biometric decryption/authentication technique employing synthetic biometric information.

FIG. 2 is a timing diagram illustrating operations performed by components of a biometric decryption/authentication system.

FIG. 3 is a block diagram of a system on a chip (SoC) processing circuit of a mobile communication device of a user of in accordance with an illustrative example.

FIG. 4 is a block diagram of biometric decryption/authentication setup components in accordance with an illustrative example.

FIG. 5 is a block diagram of biometric decryption/authentication components in accordance with an illustrative example.

FIG. 6 illustrates an exemplary setup procedure wherein multidimensional polynomials curves are exploited in conjunction with modular arithmetic.

FIG. 7 illustrates an exemplary biometric decryption/authentication procedure for using following the setup procedure of FIG. 6.

FIG. 8 is a block diagram illustrating an example of a hardware implementation for an apparatus employing a processing system that may exploit the systems, methods and apparatus of FIGS. 1-7.

FIG. 9 is a block diagram illustrating selected components of the processing circuit of FIG. 8.

FIG. 10 is a block diagram illustrating selected instruction components of the machine-readable medium of FIG. 8.

FIG. 11 summarizes an exemplary biometric method.

FIG. 12 summarizes further aspects of the exemplary method of FIG. 11.

FIG. 13 summarizes further aspects of the exemplary method of FIG. 11 pertaining to setting up the system.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several novel features pertain to obtaining encryption keys from biometric input parameters for use in biometric authentication and decryption. Since authentication is often required before a user can begin accessing and decrypting secured data, many of the examples described herein relate to the authentication process. It should be understood that authentication need not be performed in all cases. Moreover, in addition to decryption and authentication, digital signatures can also be obtained using aspects of the techniques described herein.

In one example, a biometric authentication technique is provided that exploits synthetic fingerprints. To authenticate a user who has already established a valid cryptographic key, biometrics derived from newly input user fingerprints are compared against a biometric template database that stores information for actual fingerprints of the user and a large number of entries (e.g. a million or more) corresponding to synthetic fingerprints. The closest matches are identified and corresponding candidate cryptographic keys (or cryptographic key components) are obtained based on the matching templates. Note that the closest template match might be one of the synthetic fingerprints, but the user's actual fingerprint should be among the candidates obtained. The candidate keys are tested one at a time to access a system that is already secured with the valid key of the user. If the first candidate key is successful in accessing the system, the user is thereby immediately authenticated. Otherwise, the next candidate is tested. The process continues until either the user is authenticated or until none of the candidate keys is found to successfully authenticate the user, in which case the user is not authenticated. The key may be, for example, a symmetric key (such as an Advanced Encryption Standard (AES key)) or a private key for an asymmetric key (or public key) usage. The key may also be a seed for initializing a pseudo-random generator from which a symmetric key or private key is generated. Techniques described herein are well-suited for use with, for example, Rivest/Shamir/Adleman (RSA) or El Gammel cryptographic protocols.

Herein, “synthetic” fingerprints refer to artificial fingerprints generated (by, for example, a computer) so that it is substantially not possible (but for a small probability) to distinguish the artificial fingerprint from a real fingerprint in terms of its origin, i.e. to distinguish whether it is real or artificial. For example, the synthetic fingerprint may be generated by an algorithm, procedure or device using a distribution of many real fingerprints as an input, as opposed to one real fingerprint. More generally, synthetic biometric parameters (or synthetic biometric data, synthetic biometric information, synthetic biometric data objects, etc.) herein refer to artificial biometric parameters generated so that it is substantially not possible (but for a small probability) to distinguish the artificial biometric parameters from a real biometric parameters in terms of its origin, i.e. to distinguish whether the biometric parameters are real or artificial. Synthetic fingerprints are discussed, for example, in U.S. Published Application 2014/0003679 and U.S. Pat. No. 6,961,452. Systems have been developed for generating synthetic fingerprints for use in testing fingerprint recognition algorithms. See, for example, Cappelli, “SFinGe: an Approach to Synthetic Fingerprint Generation” DEIS—University of Bologna—Italy, 2004. Other exemplary synthetic biometric parameters include synthetic iris scan parameters, synthetic voiceprint parameters, etc.

In an illustrative example, the biometric readings from the user are associated with points or “offsets” in a multi-dimensional space using modular arithmetic (such as modular arithmetic involving prime numbers interpolated over a group space using a generator.) See, e.g., techniques described in Shamir, “How to Share a Secret,” Communications of the ACM 22 (11): 612-613, 1979. A sufficient number of offsets specify a unique multidimensional polynomial curve, which corresponds to a unique cryptographic key for the user. In this manner, multiple biometric readings from a user yield multiple points on the curve, thereby allowing a key for the user to be derived. With this technique, a cryptographic key (or key component) is thereby generated where any sufficiently large quorum of sufficiently similar sensor readings provided later enables the generation of the same key.

During a setup procedure, the user provides a set of biometric readings such as a full set of fingerprints and thumbprints. For each biometric reading, an associated biometric template is generated and stored in a database. A multidimensional curve is randomly (or pseudorandomly) selected for the user and points (i.e. offsets) along that curve are also randomly (or pseudorandomly) selected using modular arithmetic. Each biometric template for the user is associated with one of the points/offsets on the curve so that a sufficient number of biometric templates uniquely specifies the curve. The curve, in turn, uniquely specifies a cryptographic key component by, for example, using the point of intersection of the curve with the y-axis as a numerical indicator of the key component. (In some examples, one of the points may provide a password or a password may be used to generate a point) The cryptographic key component for the user is employed, in one example, as the private key of a public/private key pair and a key exchange is performed with at least one secure system. The biometric templates for the user are stored in a database along with a large number of templates derived from synthetic biometric data such as synthetic fingerprints. Preferably a million or more synthetic templates are employed to provide sufficient entropy. The real templates are stored along with the synthetic templates such that the real templates are indistinguishable from the synthetic templates. (It is assumed that the template database could be breached, and the associated templates and offsets leaked.)

Thereafter, during a subsequent authentication procedure, the user enters new biometric scans of fingerprints, thumbprints, etc., and these scans are compared with templates in the database to identify the four or five closest matching biometric templates. That is, for each individual fingerprint, several matching templates are found and, for each thumbprint, several matching templates are also found. Due to the general “fuzziness” in the sensor readings, the closest matching template might be a synthetic template, yet the authentic template for the user should be among the matching templates. For each matching template, the corresponding offset is retrieved from the database. The offsets for each of the fingerprints and thumbprints are used to specify a multidimensional polynomial curve (again using modular arithmetic.) The curve specifies a candidate cryptographic key component, which is then tested by applying it to the secure system to determine if it successfully gains access to that system (by, for example, using the key to decrypt a login code received from the secure device to prove the user is authorized to access the system.) If the cryptographic key component successfully gains access to the system, the user is thereby authenticated and the cryptographic key component is validated as the user's key. If not, the cryptographic key component corresponding to the next candidate is tested, and so on, until either the user is authenticated, or the last of the candidates fails and the user is thereby not authenticated.

The method thereby allows a user to generate a key from a sufficient set of biometric readings, where the key is “stable” in spite of the fuzzy nature of each reading. In one particular example, a collection of twelve user-provided templates are associated with twelve randomly selected points on the polynomial associated with that user. If another user provides only nine biometric readings, then nine randomly selected points on the polynomial would be used for that user. For no user would the point x=0 be used; the y-coordinate of this point is, in some examples, the key value. Perhaps the greatest computational cost associated with the technique involves identifying matching templates from a set of biometric readings. This is a well-known problem that exists in any system used for identification (as opposed to authentication). There are known search algorithms used, for example, in the context of forensics that may be employed.

To summarize some aspects of the exemplary technique for user authentication after the template database has been constructed:
1. The user provides a sufficient number of biometric readings to uniquely identify the polynomial for the user. If, for example, the system is set to select degree-5 polynomials, then six readings would uniquely determine the polynomial.
2. For each biometric reading, a small number of matching templates are determined by examining the template database, where a matching template is a template that is a reasonably close match to an associated biometric reading.
3. For each such constellation or set of matching templates, the associated offsets are selected and the associated polynomial is generated from which a candidate cryptographic key (or key component) is derived.
4. The candidate key is verified by testing and, if verification is successful, the user is authenticated and the key is validated; otherwise, the next candidate is tested. If each reading yields, e.g., four matching templates and six points define the polynomial, then a total of 4⁶=4096 candidate keys would need to be tested in a worst case.

An attacker breaching the database would not know what template is associated with what user or with what account. The attacker would also not know what templates correspond to one and the same user. In other words, if there are a million templates and associated offsets and the polynomial used for a given user is a degree-5 polynomial, the attacker would need to select six templates to determine the key associated with the polynomial, where the attacker would use polynomial interpolation. Since a million is approximately 2²⁰, this approach provides about 120 bits of entropy against an attacker that has breached the database—and substantially more against an adversary who has not. (Note that the polynomial points would be indistinguishable from random values drawn uniformly at random from the space, provided the coefficients of the polynomial are selected in that manner.) If there are a larger number of templates, such as two million, then the resulting security is not 120 bits, but 126 bits—corresponding to one extra bit of entropy per degree of the polynomial, and a degree-5 polynomial. However, if the degree of the polynomial is substantially lower, such as 3, then that would result in only 4*20=80 bits of entropy, which in some systems would be insufficient. However, by introducing synthetic templates that are not associated with any user but which are indistinguishable from those of real users, the entropy can be increased. For example, by artificially increasing the number of templates from a million to 64 million, an additional six bits of entropy is added for each necessary reading, bringing the security to 4*26=104 bits for a degree-three polynomial.

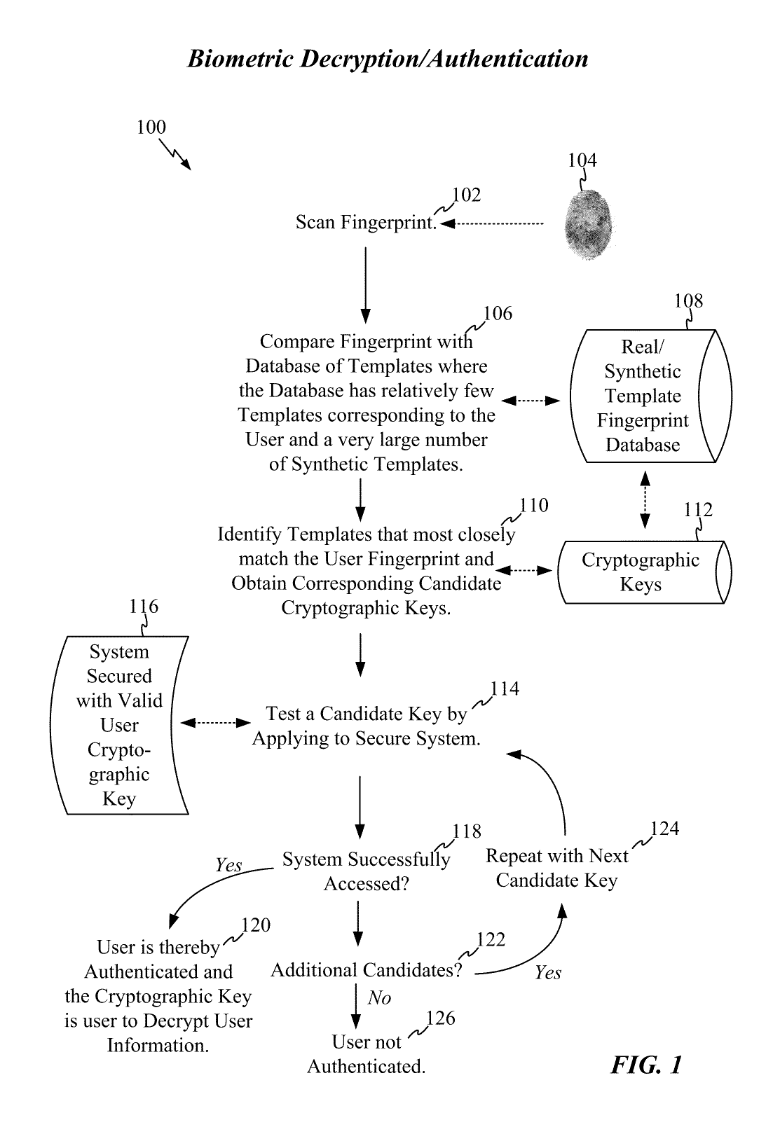

FIG. 1 provides a broad overview of a biometric authentication procedure 100 exploiting synthetic biometric information for an example where fingerprints are used. At 102, a fingerprint 104 is scanned. At 106, the fingerprint is compared with a database 108 of templates where the database has relatively few templates corresponding to the user and a very large number of synthetic templates. At 110, templates are identified that most closely match the user fingerprint and corresponding candidate cryptographic keys are obtained from a database (or other key generation device) 112, which may operate in conjunction with the template database 108. At 114, a candidate cryptographic key is tested by applying to a secure system 116, which has already been secured with a valid user key. At 118, if the system is successfully accessed by the candidate key, the user is thereby authenticated, at 120, and the candidate cryptographic key is thereby validated as the correct key for the user. If not, then the process returns to 114 via 122 and 124 to repeat the test with a next candidate key (assuming there are additional candidate keys to be tested.) If none of the candidate keys successfully accesses the secured system 116, then the user is not authenticated, at 126.

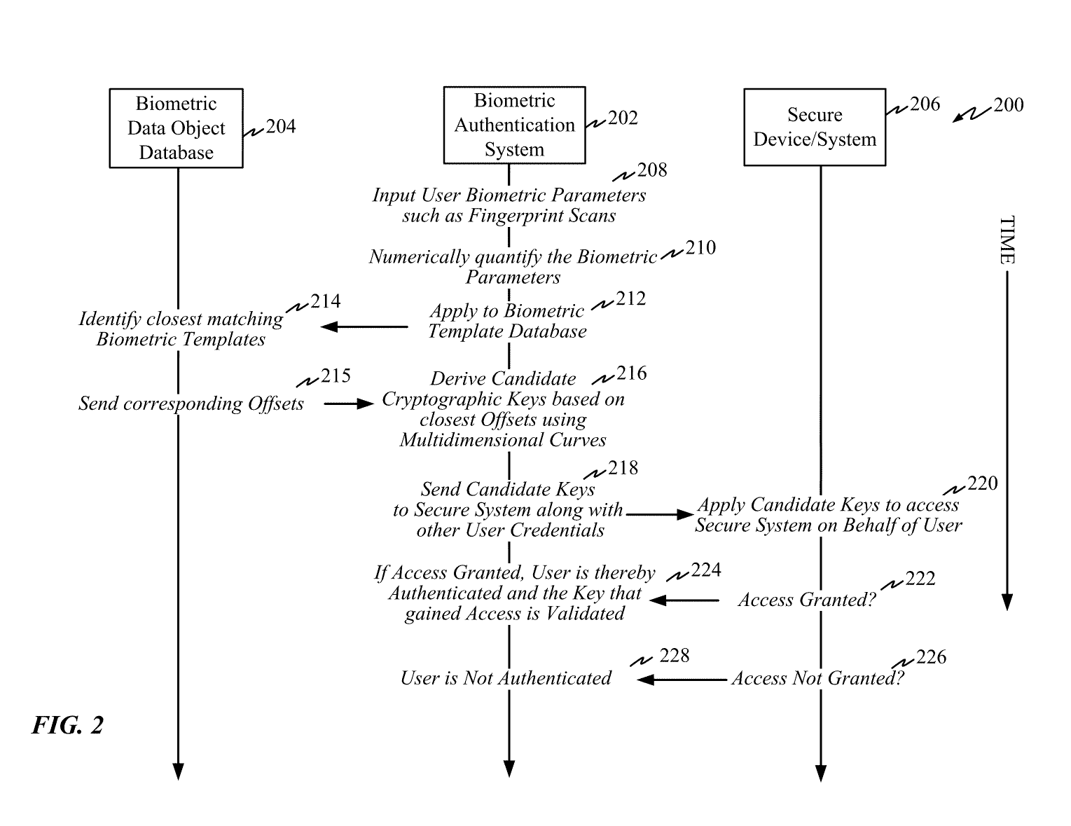

FIG. 2 summarizes some of the features of the aforementioned biometric authentication method with reference to a timing diagram 200 illustrating operations of a biometric authentication system 202, a biometric data object database 204 for storing biometric templates and corresponding offsets and a secure device or system 206 to be accessed using a biometrically-generated cryptographic key. At 208, the biometric authentication system 202 inputs user biometric parameters such as fingerprint scans and, at 210, numerically quantifies the biometric parameters for template comparison. At 212, the biometric authentication system 202 applies numeric data corresponding to the biometric parameters to the biometric data object database, which then identifies the closest matching biometric templates, at 214. At 215, the corresponding offsets are sent to the biometric authentication system 202, which derives candidate cryptographic keys, at 216, based on the offsets using multidimensional curves (by, e.g., identifying the y-axis intersection of the curve using modular arithmetic.) At 218, the biometric authentication system 202 sends the candidate keys (typically one at a time) to the device/system 206 along with other user credentials such as a user name.

The device/system 206 applies the candidate keys, at 220, to access its secure systems on behalf of the user (such as by decrypting data previously encrypted on behalf of the user.) If access is granted, at 222, the biometric authentication system 202 indicates, at 224, that the user is thereby authenticated and the key that gained access is validated as the correct user key. Preferably, operations 216-224 are performed sequentially to derive one candidate key at a time for applying to the secure/system with the candidate key corresponding to the offsets of the closest matching template(s) being derived and applied first. However, in some examples, the various candidate keys might be derived and applied in parallel. If none of the candidate keys gains access to the secure/device system 206, then at 226 the biometric authentication system is informed, which responds by indicating that the user is not authenticated, 228. Depending upon device programming, the biometric authentication system may then instruct the user to reapply the fingerprints or other biometric input so that the procedure may be repeated (in case the original fingerprints were smudged and hence not suitable for biometric authentication.) In any case, assuming a candidate key successfully gains access to the secure device/system 206, the secure device/system may respond by returning confidential data for display to the user or by performing other operations requested by the user, such as financial transactions, etc. Note that the secure device/system may generally be any of a wide variety of systems or devices (or components thereof) such as a secure website, a cloud server database or a component of a mobile device.

### Illustrative Biometric Decryption/Authentication Systems and Methods

Various exemplary systems and methods will now be described for deriving cryptographic keys from biometrics for decryption and/or authentication. In many of the examples, a smartphone is employed for inputting biometric parameters such as fingerprints. For the sake of completeness, a brief description of the hardware of an exemplary smartphone will be set forth, which includes components for setting up the biometric system and for controlling subsequent decryption and/or authentication. In general, any of a wide variety of mobile or fixed devices or systems may employ components for biometric decryption and/or authentication.

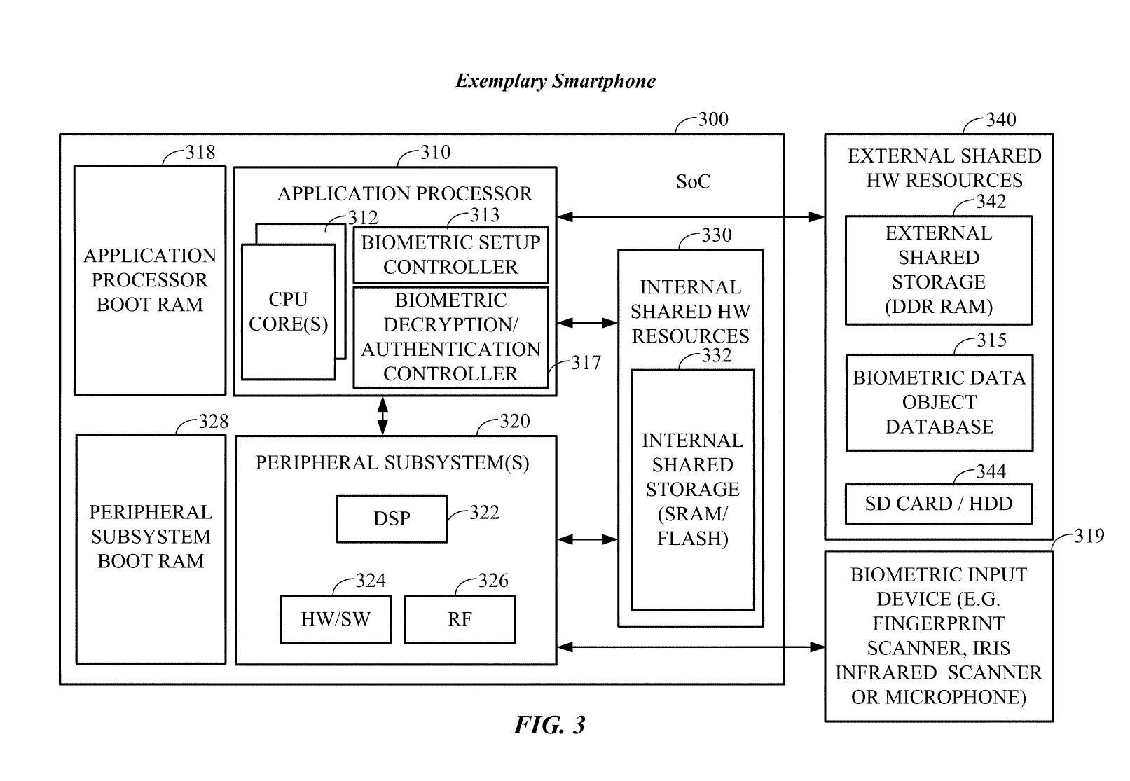

FIG. 3 illustrates a system on a chip (SoC) processing circuit 300 of a smartphone or other mobile communication device in accordance with one example where various novel features may be exploited. The SoC processing circuit may be a Snapdragon™ processing circuit manufactured by Qualcomm Incorporated. SoC processing circuit 300 includes an application processing circuit 310, which includes a multi-core CPU 312. Application processing circuit 310 typically controls operation of all components of the mobile communication device. In one aspect, application processing circuit 310 includes a biometric setup controller 313 for creating and populating a biometric data object database 315 having relatively few authentic user biometric templates and a very large number of synthetic biometric templates. The application processing circuit 310 also includes a biometric decryption/authentication controller 313 for subsequently authenticating a user by processing newly input biometric parameters received via a biometric input device 319 (such as a fingerprint scanner, iris scanner or microphone) and/or for decrypting data previously encrypted on behalf of the user. Depending upon the implementation, the iris scanner may exploit a digital camera (not separately shown) of the smartphone, particularly one equipped for infrared (IR) sensing.

Typically, when the user first begins using the smartphone following purchase, the user performs an initial biometric setup procedure under the control of the biometric setup controller 313 by carefully and precisely entering fingerprints from all ten fingers/thumbs (or inputting iris scans for both eyes and/or entering other suitable biometric parameters such as knuckle prints, voice prints, etc.) from which biometric templates are generated. The templates derived from the user are employed to populate the biometric data object database 315, which is preferably pre-stored with a very large number of synthetic biometric templates. As noted, the user templates are associated with points or offsets on a multidimensional curve unique to the user so that a sufficient number of biometric parameters subsequently input by the user can then specify the multidimensional curve, which in turn specifies a cryptographic key component for the user. The cryptographic key component may be used as part of a key exchange with various secure systems, which may be other components of the smartphone or external systems such as a cloud servers or websites.

Thereafter, whenever the user needs to authenticate himself or herself for accessing one of those secure systems (so as to access sensitive information, perform a significant financial transactions, decrypt data, etc.,) the user enters fingerprints from several fingers/thumbs and/or performs an iris scan of one eye (or records suitable words for voiceprint recognition, etc.) That is, following the initial setup, authentication does not require all ten fingers/thumbs or both eyes. Rather, fewer scans are needed. The biometric decryption/authentication controller 317 uses the newly input scans to identify matching templates within the biometric object database 315 from which the user's cryptographic key can be obtained (by exploiting the aforementioned multidimensional curve via modular arithmetic) for use in authenticating the user and/or for decrypting data previously encrypted with the user key.

For added convenience, the user may be permitted to employ a less reliable form of authentication (or no authentication at all) for accessing less sensitive information or for performing modest financial transactions. For example, to simply turn on the phone, the user may enter a quick four digit pass code. To authorize a modest purchase, no further authentication may be required. The more reliable authentication performed by biometric decryption/authentication controller 317 may be required in some examples only for accessing bank accounts or other sensitive information, changing fundamental hardware settings of the smartphone, or authorizing more significant purchases or other financial transactions. As such, should the smartphone be misplaced, lost or stolen, a third party obtaining the smartphone cannot then use the device to access sensitive information or make large financial transactions. The biometric techniques described herein are primarily for obtaining decryption keys and/or for performing user authentication but can potentially be used for other purposes such as generating encryption keys or for signing documents, etc.

Application processing circuit 310 may also include a boot ROM 318 that stores boot sequence instructions for the various components of SoC processing circuit 300. SoC processing circuit 300 further includes one or more peripheral subsystems 320 controlled by application processing circuit 310. Peripheral subsystems 320 may include but are not limited to a storage subsystem (e.g., read-only memory (ROM), random access memory (RAM)), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., encryption, digital rights management (DRM)), an input/output (I/O) subsystem (e.g., keyboard, touchscreen) and wired and wireless connectivity subsystems (e.g., universal serial bus (USB), Global Positioning System (GPS), WiFi, Global System Mobile (GSM), Code Division Multiple Access (CDMA), 4G Long Term Evolution (LTE) modems). Exemplary peripheral subsystem 320, which is a modem subsystem, includes a DSP 322, various hardware (HW) and software (SW) components 324, and various radio-frequency (RF) components 326. In one aspect, each peripheral subsystem 320 also includes a boot ROM 328 that stores a primary boot image (not shown) of the associated peripheral subsystems 320.

SoC processing circuit 300 further includes various internal shared HW resources 330, such as an internal shared storage 332 (e.g. static RAM (SRAM), double-data rate (DDR) synchronous dynamic (SD) RAM, DRAM, Flash memory, etc.), which is shared by application processing circuit 310 and various peripheral subsystems 320 to store various runtime data. In one aspect, components 310, 318, 320, 328 and 330 of SoC processing circuit 300 are integrated on a single-chip substrate. SoC processing circuit 300 further includes various external shared HW resources 340, which may be located on a different chip substrate and communicate with the SoC processing circuit 300 via a system bus (not shown). External shared HW resources 340 may include, for example, an external shared storage 342 (e.g. DDR RAM, DRAM, Flash memory) and/or permanent data storage 344 (e.g., a Secure Digital (SD) card or Hard Disk Drive (HDD), etc.), which are shared by application processing circuit 310 and various peripheral subsystems 320 to store various types of data, such as an operating system (OS) information, system files, programs, applications, user data, audio/video files, etc. When the mobile communication device incorporating the SoC is activated, secure SoC processing circuit 300 begins a system boot up process. In particular, application processing circuit 310 accesses boot ROM 318 to retrieve boot instructions for SoC processing circuit 300, including boot sequence instructions for various peripheral subsystems 320. Peripheral subsystems 320 may also have additional peripheral boot RAM 328.

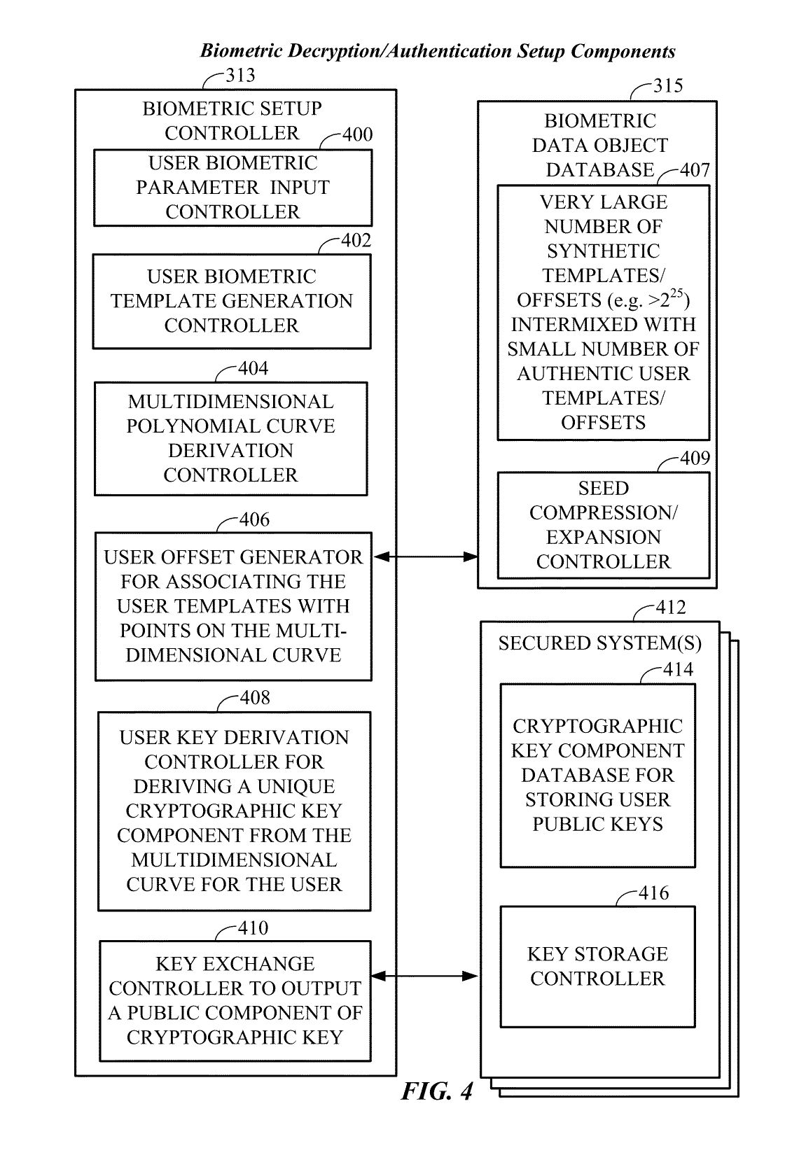

FIG. 4 illustrates selected biometric decryption/authentication setup components for use in the initial setup procedure. Only selected components pertinent to the setup procedure are shown within the various devices. Each device may include other components for implementing other functions. Referring first to the biometric setup controller 313, the controller 313 controls the biometric decryption/authentication setup or initialization procedure to populate the biometric data object database 315. The biometric setup controller 313 includes a user biometric parameter input controller 400 for inputting biometric parameters such as fingerprint scans or iris scans (or voice samples, etc.) using a suitable input device, such as device 319 of FIG. 3. Preferably, all ten fingerprints/thumbprints are entered and/or both eyes are scanned. For vocal biometric authentication, a relatively large number of predetermined words may be recorded from the user via a microphone. A user biometric template generation controller 402 then generates a template for each biometric parameter. That is, one biometric template is generated from the scan of the right forefinger, another biometric template is generated from the scan of the left forefinger, etc. For vocal recognition, a different biometric template is generated for each word (or groups of words spoken together.) For iris scans, one biometric template is generated for each of various predetermined portions or quadrants of the iris such as the top left quadrant of the right eye, the top left quadrant of the left eye, etc. Any of a variety of suitable techniques can be used to generate the templates by numerically quantifying the biometric inputs such as those commonly employed with automated fingerprint analysis or generally employed for voice recognition.

A multidimensional polynomial curve derivation controller 404 randomly or pseudorandomly selects or otherwise derives a multidimensional curve for the user for use with modular arithmetic and randomly or pseudorandomly selects points on the curve. A user offset generator 406 then associates each user template with one of the points of the multidimensional curve, where the point on the curve is also referred to herein as an offset. For example, the template corresponding to the right forefinger is associated with one of the points on the curve, whereas the template corresponding to the left forefinger is associated with another of the points on the curve. A sufficient number of points are defined on the curve in this manner to “over determine” the curve so that a subset or quorum of points can thereafter be used to identify the curve during subsequent user authentication. The templates and corresponding offsets are then stored within the biometric data object data base 315, which is pre-stored or pre-provisioned with a very large number of synthetic templates and offsets 407 corresponding to synthetic fingerprints, iris scans, voiceprints, etc. The authentic user templates/offsets are intermixed within the database with the synthetic templates/offsets so that the source of any particular templates/offset is not retained or is otherwise obscured (so that a hacker cannot determine whether a particular template is a synthetic template or a real template.) A seed compression/expansion controller 409 may be used to compress the resulting database into a compact seed that allows regeneration of the database on demand so as to save storage space. The initial set of synthetic templates/offsets (without the added authentic user components) may also be pre-stored as an initial compact seed.

A user key derivation controller 408 is operative to derive a unique cryptographic key component from the multidimensional curve for the user, such as a private key component of a public/private key pair. As already explained, this may be achieved by using a point of intersection of the multidimensional curve with a predetermined axis (such as the y-axis) as an identifier for the key component using modular arithmetic. In some examples, the intersection point is used as the key component. In other examples, the intersection point is instead used as input to generate a key based on some generator function or as a pointer into a lookup table. To save storage space, in some examples, only a single actual key is stored with all additional keys generated based on offsets from that stored key.

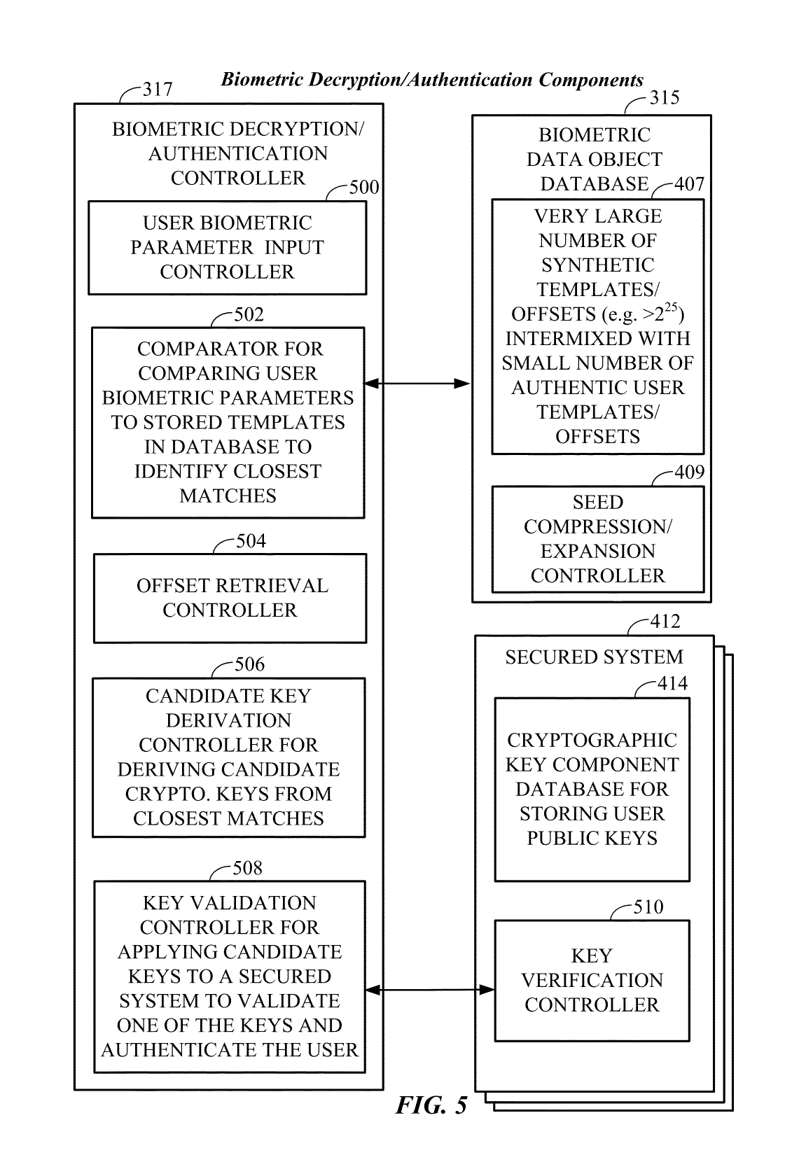

In some examples, a key exchange controller 410 then outputs a public component of the cryptographic key to one or more secured systems 412 for storage therein in accordance, e.g., with a public key/private key exchange procedure with the device to facilitate a subsequent user authentication (by, for example, using the private key to decrypt a login code received from the secure device.) An exemplary secured system 412 is shown in FIG. 4, which includes a cryptographic key component database for storing one or more public keys and a key storage controller for controlling the storage operation. Similar key exchanges may be performed with wide variety of components, systems or devices such as websites, cloud servers or other devices within a home, office or personal network or other components with the smartphone. Thereafter, as will be explained with reference to FIG. 5, the user can authenticate himself or herself when accessing such components or devices by re-generating the user cryptographic key from newly-entered biometric parameters for validation by a particular secured system 412. It is noted that many secured systems impose a limit on the number of attempts that may be made to access the system. Hence, for use with such systems, it may be preferable to authenticate the user with an on-board system of the smartphone that does not impose a limit. Once on-board authentication is achieved, a validated key for the user is exchanged with external systems to gain access to those systems.

FIG. 5 illustrates selected biometric decryption/authentication components for use when the user seeks to gain access to one of the secured systems 412 or for decrypting data, etc. Again, only selected components are shown. Biometric decryption/authentication controller 317 controls decryption and/or authentication based on templates/offsets stored in the biometric data object database 315. The controller 317 begins by inputting newly entered biometric parameters such as fingerprints or iris scans under the control a user biometric parameter input controller 500 (via a scanner such as scanner 319 of FIG. 3.) However, for the purposes of user authentication, only a subset (e.g. five) of the fingerprints/thumbprints used to setup the system are entered and/or only a single eye is scanned. For vocal biometric authentication, a relatively small number of predetermined words are input via a microphone. A comparator 502 compares the input biometric parameters to stored templates in the biometric database 315 to identify the closest matches based on similarity score or other suitable procedure. The number of matches returned may be a programmable value but, in a typical example, three to five templates are identified by the offset comparator 502 for each biometric parameter (e.g. four templates are retrieved corresponding to the right forefinger scan, four templates are retrieved correspond to the left forefinger scan, etc.) An offset retriever controller 504 retrieves the offsets from the database 407 corresponding to the matching templates. As already explained, the offsets identify points in a multidimensional space via modular arithmetic.

A candidate key derivation controller 506 derives a candidate cryptographic key component for the user for each set of matching templates to, e.g., obtain a private key component of a public/private key pair. That is, the candidate key derivation controller 506 uses the offsets corresponding to the matching templates to specify a multidimensional curve, which in turn specifies a key component based on an intersection of the curve and the y-axis. If the matches used to derive the key component correspond to the user, the resulting key will be valid. If the matches correspond to synthetic templates in the database, the resulting key will not be valid. In an illustrative example, the user enters fingerprint scans corresponding to the thumb and fingers of the right hand. Each of these is used to retrieve the four closest matching templates. One of these will mostly likely correspond to the user, whereas the others will be synthetic. Each combination of five “matching” templates (corresponding to the fingers/thumb of the right hand) defines a candidate multidimensional curve (via the offsets stored for those templates), which in turn specifies a candidate key component. However, only the templates that actually correspond to the user will identify the correct multidimensional curve of the user and point to a valid key component. The other (synthetic) templates will identify different curves that point to different keys that are not valid.

A key validation controller 508 then outputs a public component of a candidate cryptographic key to a selected one of the secured systems 412. A key verification controller 510 of the secured system 412 employs the key along with data obtained from its cryptographic key component database to determine if the key is valid (e.g. to determine if the key decrypts user data and/or otherwise gains access to secure content.) The key verification controller 510 returns a value to the key validation controller 508 of the biometric authentication controller 317 indicating whether access was successful. As already explained, candidate keys can be applied sequentially until a valid key is applied (indicating the user is authenticated and the key is validated) or until there are no further candidate keys (indicating that the user is not authenticated.)

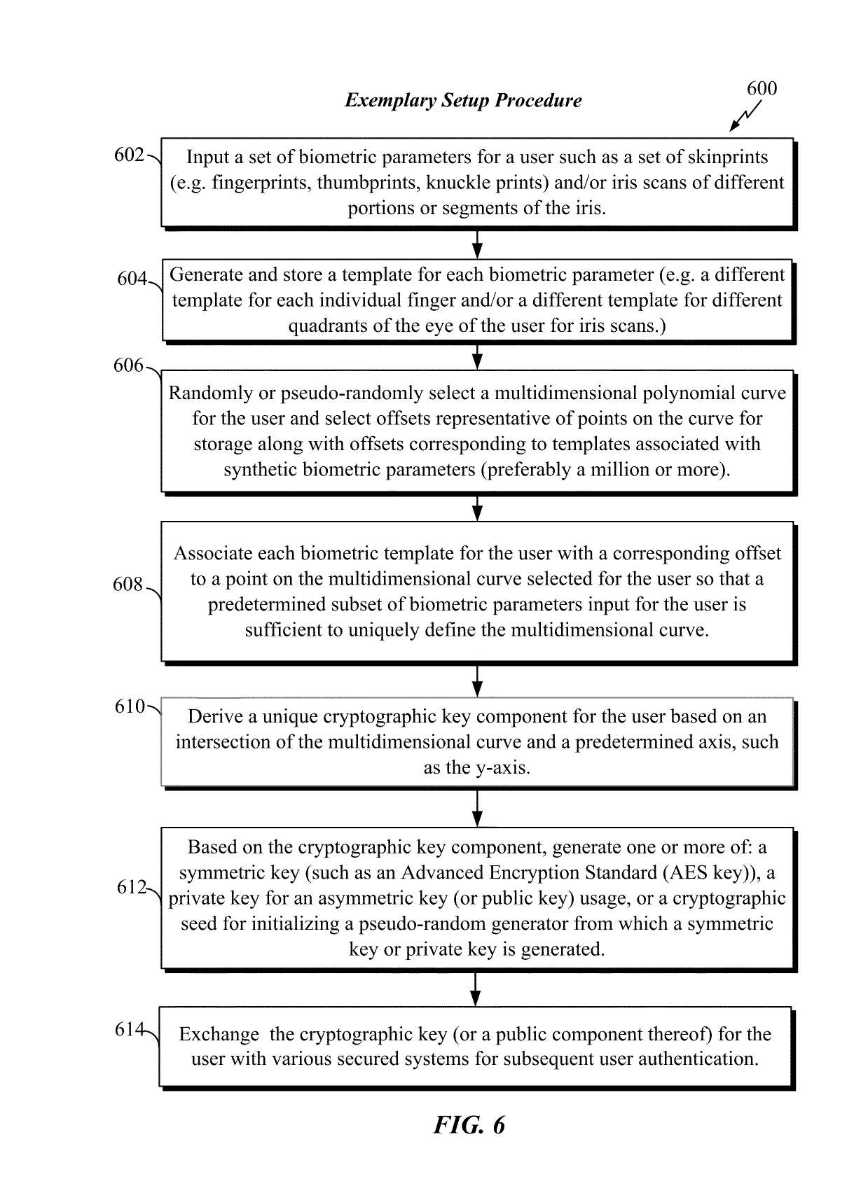

FIG. 6 is a flowchart 600 illustrating a set up procedure 600 that maybe performed by the components of FIG. 4. At 602, the smartphone or other user device inputs a set of biometric parameters for a user such as a set of skinprints (e.g. fingerprints, thumbprints, knuckle prints) and iris scans of different portions or segments of the iris. At 604, the smartphone generates and stores a template for each biometric parameter (e.g. a different template for each individual finger and/or a different template for different quadrants of the eye of the user for iris scans.) At 606, the smartphone randomly or pseudo-randomly selects a multidimensional polynomial curve for the user and randomly or pseudo-randomly select offsets representative of points on the multidimensional curve for storage along with offsets corresponding to templates associated with synthetic biometric parameters (preferably a million or more).

At step 608, the smartphone associates each biometric template for the user with a corresponding offset to a point on the multidimensional curve selected for the user so that a predetermined subset of biometric parameters input for the user is sufficient to uniquely define the multidimensional curve. At 610, the smartphone derives a unique cryptographic key component for the user based on an intersection of the multidimensional curve and predetermined axis such as the y-axis. At 612, based on the cryptographic key component, the smartphone generates one or more of: a symmetric key (such as an AES key), a private key for an asymmetric key (or public key) usage, or a cryptographic seed for initializing a pseudo-random generator from which a symmetric key or private key is generated. At 614, the smartphone exchanges the cryptographic key (or a public component thereof) for the user with various secured systems for subsequent user authentication.

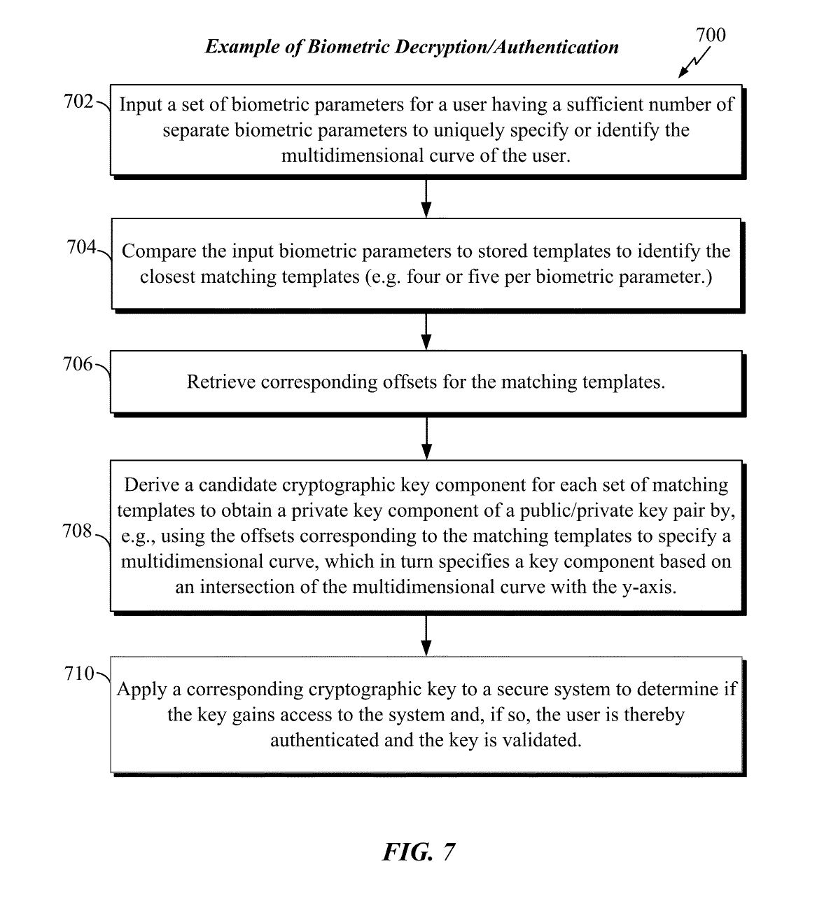

FIG. 7 is a flowchart 700 illustrating procedure 600 that maybe performed by the components of FIG. 5 for decryption and/or authentication. At 702, the smartphone or other user device inputs a set of biometric parameters for a user having a sufficient number of separate biometric parameters to uniquely specify or identify the multidimensional curve of the user (selected during the procedure of FIG. 6.) At 704, the smartphone compares the input biometric parameters to stored templates to identify the closest matching templates (e.g. three, four or five per biometric parameter) and, at 706, retrieves the corresponding offsets for the matching templates from the database. At 708, the smartphone derives a candidate cryptographic key component for each set of matching templates to obtain a private key component of a public/private key pair by, e.g., using the offsets corresponding to the matching templates to specify a multidimensional curve, which in turn specifies a key component based on an intersection of the multidimensional curve with the y-axis. At 710, the smartphone applies a corresponding cryptographic key to a secure system to determine if the key gains access to the system and, if so, the user is thereby authenticated and the key is validated, as already explained.

### Further Exemplary Systems, Methods and Apparatus

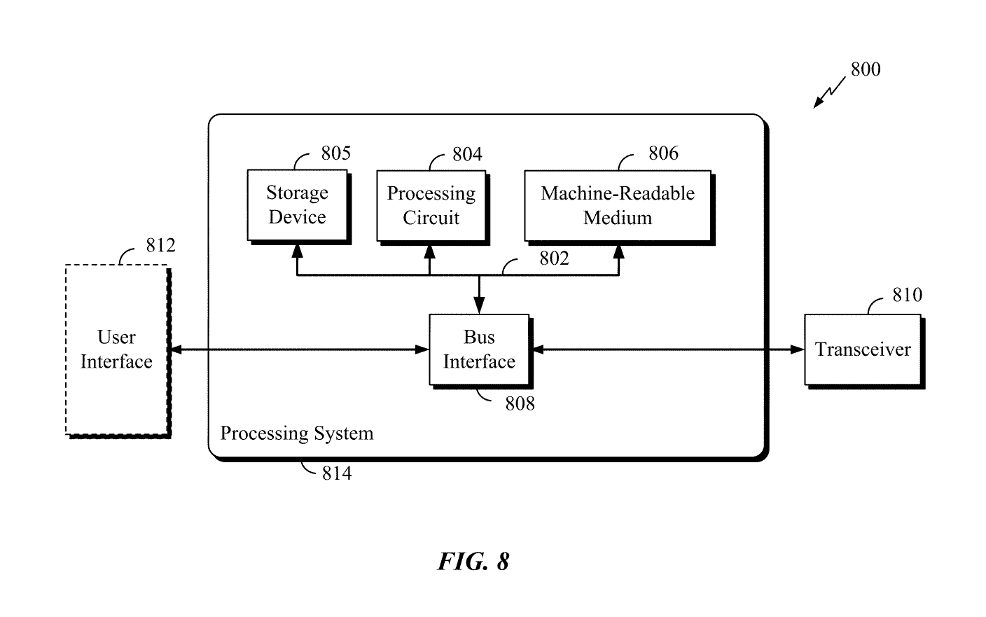

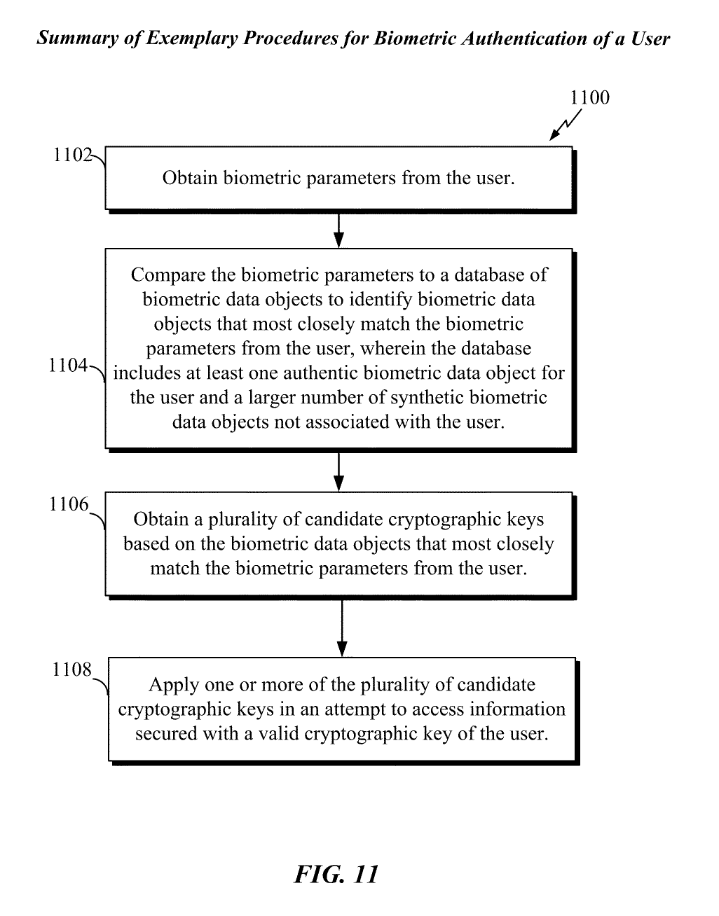

FIG. 8 illustrates an overall system or apparatus 800 in which the components and methods of FIGS. 1-7 may be implemented. In accordance with various aspects of the disclosure, an element, or any portion of an element, or any combination of elements may be implemented with a processing system 814 that includes one or more processing circuits 804 such as the SoC processing circuit of FIG. 3. For example, apparatus 800 may be a user equipment (UE) of a mobile communication system. Apparatus 800 may be used with a radio network controller (RNC). In addition to an SoC, examples of processing circuits 804 include microprocessing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. That is, processing circuit 804, as utilized in apparatus 800, may be used to implement any one or more of the processes described above and illustrated in FIGS. 1-7 (and those illustrated in FIGS. 11-13, discussed below), such as processes to perform user authentication based on biometrics.

In this example, processing system 814 may be implemented with a bus architecture, represented generally by the bus 802. Bus 802 may include any number of interconnecting buses and bridges depending on the specific application of processing system 814 and the overall design constraints. Bus 802 links together various circuits including one or more processing circuits (represented generally by the processing circuit 804), storage device 805, and a machine-readable, processing circuit-readable or computer-readable media (represented generally by a non-transitory machine-readable medium 806.) Bus 802 may also link various other circuits such as timing sources, peripherals, voltage regulators, and power management circuits, which are well known in the art, and therefore, will not be described any further. Bus interface 808 provides an interface between bus 802 and a transceiver 810. Transceiver 810 provides a means for communicating with various other apparatus over a transmission medium. Depending upon the nature of the apparatus, a user interface 812 (e.g., keypad, display, speaker, microphone, joystick) may also be provided.

Processing circuit 804 is responsible for managing bus 802 and general processing, including the execution of software stored on the machine-readable medium 806. The software, when executed by processing circuit 804, causes processing system 814 to perform the various functions described herein for any particular apparatus. The machine-readable medium 806 may also be used for storing data that is manipulated by processing circuit 804 when executing software.

One or more processing circuits 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 806. The machine-readable medium 806 may be a non-transitory machine-readable medium. A non-transitory processing circuit-readable medium, processor-readable medium, machine-readable medium, or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a computer. The terms “machine-readable medium”, “computer-readable medium”, “processing circuit-readable medium”, and/or “processor-readable medium” may include, but are not limited to, non-transitory media such as portable or fixed storage devices, optical storage devices, and various other media capable of storing, containing or carrying instruction(s) and/or data.

Thus, the various methods described herein may be fully or partially implemented by instructions and/or data that may be stored in a “machine-readable medium,” “computer-readable medium,” “processing circuit-readable medium,” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer. The machine-readable medium 806 may reside in processing system 814, external to processing system 814, or distributed across multiple entities including processing system 814. The machine-readable medium 806 may be embodied in a computer program product. By way of example, a computer program product may include a processing circuit-readable medium in packaging materials. Those skilled in the art will recognize how best to implement the described functionality presented throughout this disclosure depending on the particular application and the overall design constraints imposed on the overall system.

In particular, the machine-readable storage medium 806 may have one or more instructions which when executed by processing circuit 804 causes the processing circuit to: obtain biometric parameters from the user; compare the biometric parameters to a database of biometric data objects to identify biometric data objects that most closely match the biometric parameters from the user, wherein the database includes at least one authentic biometric data object for the user and a larger number of synthetic biometric data objects not associated with the user; obtain a plurality of candidate cryptographic keys based on the biometric data objects that most closely match the biometric parameters from the user; and apply one or more of the plurality of candidate cryptographic keys in an attempt to access information secured with a valid cryptographic key of the user.

One or more of the components, steps, features, and/or functions illustrated in the figures may be rearranged and/or combined into a single component, step, feature or function or embodied in several components, steps, or functions. Additional elements, components, steps, and/or functions may also be added without departing from the features and aspects described. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

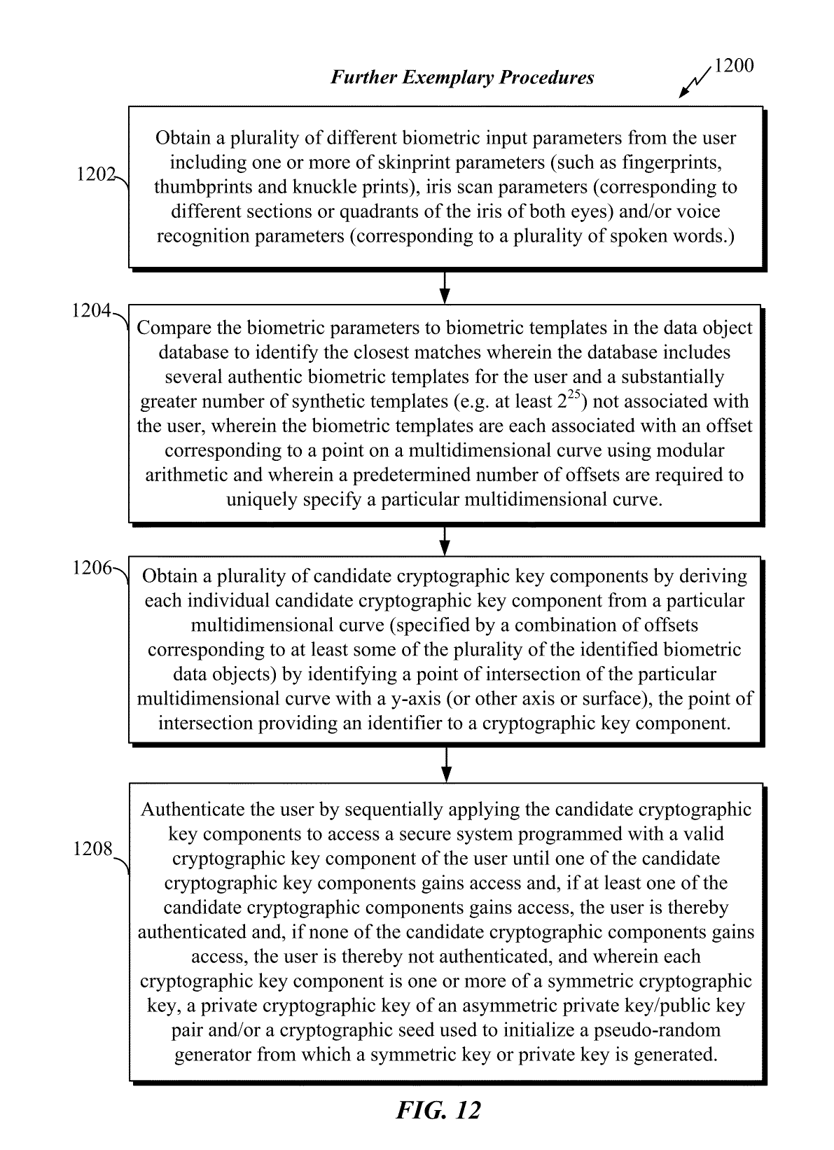

Hence, in one aspect of the disclosure, processing circuit 300 and/or 804 illustrated in FIGS. 3 and 8, respectively, may be a specialized processing circuit (e.g., an ASIC)) that is specifically designed and/or hard-wired to perform the algorithms, methods, and/or steps described in FIGS. 2, 6 and/or 7 (and/or FIGS. 11, 12, and/or and 13, discussed below.) Thus, such a specialized processing circuit (e.g., ASIC) may be one example of a means for executing the algorithms, methods, and/or steps described in FIGS. 2, 6 and/or 7 (and/or FIGS. 11, 12, and/or and 13, discussed below.) The machine-readable storage medium may store instructions that when executed by a specialized processing circuit (e.g., ASIC) causes the specialized processing circuit to perform the algorithms, methods, and/or steps described herein.

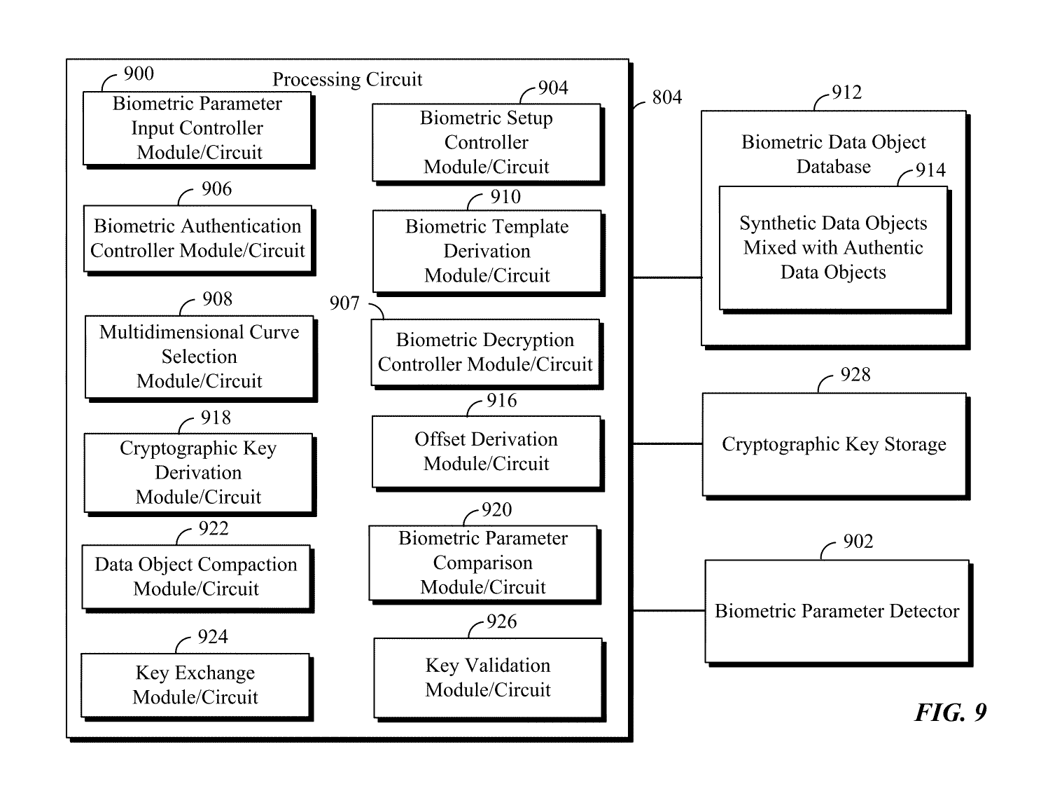

FIG. 9 illustrates selected and exemplary components of the processing circuit 804. In particular, processing circuit 804 of FIG. 9 includes a biometric parameter input controller module/circuit 900 operative to obtain biometric input parameters from the user via a biometric parameter detector 902. A biometric setup controller module/circuit 904 is operative to control setup or initialization functions. A biometric authentication controller module/circuit 906 is operative to control subsequent user authentication functions. A biometric decryption controller module/circuit 907 is operative to control subsequent decryption functions. These controllers may control one or more of the other components shown in FIG. 9.

A multidimensional curve selection module/circuit 908 is operative to select the multidimensional curve for the user. A biometric template derivation module/circuit 910 is operative, for each of the plurality of initial biometric input parameters, to generate a corresponding template for storage within a biometric data object database 912, which includes synthetic data objects mixed with authentic data objects 914. An offset derivation module/circuit 916 is operative, e.g., to select a plurality of points on the multidimensional curve of the user and associate a selected one of the plurality of points with a corresponding template. A cryptographic key derivation module/circuit 918 is operative, e.g., to obtain a cryptographic key component based on a set of offsets that uniquely specify a particular multidimensional curve and for generating a key. A biometric parameter comparison module/circuit 920 is operative to compare biometric input parameters to the database of biometric data objects to identify a plurality of biometric data objects (e.g. templates) that most closely match the biometric input parameters. A data object compaction module/circuit 922 is operative to compact the data object database 912 by, for example, converting it to a seed and further operative to expand the compacted database from the seed, as needed. A key exchange module/circuit 924 is operative to control a key exchange with a secure system (which may be another component of the device or an external system) for decrypting information. A key validation module/circuit 926 is operative to authenticate the user by confirming the validity of the cryptographic key by, for example, applying a cryptographic key to a secure system programmed with a valid cryptographic key for the user and, if the cryptographic key gains access to the secure system, indicating the user is authenticated. A cryptographic key storage device 928 is operative to store one or more cryptographic keys such as private keys that have been validated for the user.

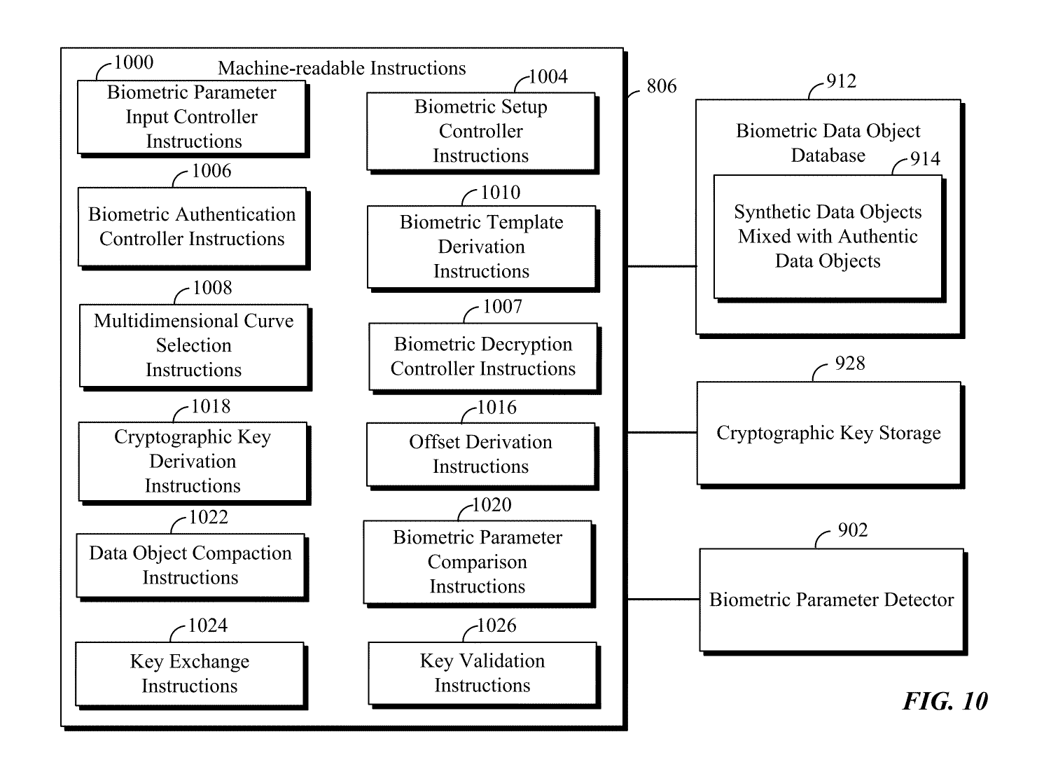

FIG. 10 illustrates selected and exemplary instruction components of the machine-readable or computer-readable medium 806. In particular, machine-readable medium 806 of FIG. 10 includes biometric input parameter controller instructions 1000, which when executed by the processing circuit of FIG. 8, causes the processing circuit to obtain biometric input parameters from the user via a biometric parameter detector 902. Biometric setup controller instructions 1004 are operative to control setup or initialization functions. Biometric authentication controller instructions 1006 are operative to control subsequent user authentication functions. Biometric decryption controller instructions 1007 are operative to control subsequent user decryption functions.

Multidimensional curve selection instructions 1008 are operative to select the multidimensional curve for the user. Biometric template derivation instructions 1010 are operative, for each of the plurality of initial biometric input parameters, to generate a corresponding template for storage within the biometric data object database 912, which includes synthetic data objects mixed with authentic data objects 914. Offset derivation instructions 1016 are operative, e.g., to select a plurality of points on the multidimensional curve of the user and associate a selected one of the plurality of points with a corresponding template. Cryptographic key derivation instructions 1018 are operative, e.g., to obtain a cryptographic key component based on a set of offsets that uniquely specify a particular multidimensional curve and to then generate a key. Biometric parameter comparison instructions 1020 are operative to compare biometric input parameters to the database of biometric data objects to identify a plurality of biometric data objects that most closely match the biometric input parameters. Data object compaction instructions 1022 are operative to compact the data object database 1012 by, for example, converting it to a seed and are further operative to expand the compacted database, as needed. Key exchange instructions 1024 are operative to control a key exchange with a secure system. Key validation instructions 1026 are operative to authenticate the user by confirming the validity of the cryptographic key by, for example, applying a cryptographic key to a secure system programmed with a valid cryptographic key for the user and, if the cryptographic component gains access to the secure system, indicating the user is authenticated.

FIG. 11 broadly illustrates and summarizes methods or procedures 1100 that may be performed by processing circuit 804 of FIG. 8 or other suitably equipped devices for biometric authentication of a user. At 1102, the processing circuit obtains biometric parameters from the user and, at 1104, compares the biometric parameters to a database of biometric data objects to identify biometric data objects that most closely match the biometric parameters from the user, wherein the database includes at least one authentic biometric data object for the user and a larger number of synthetic biometric data objects not associated with the user. At 1106, the processing circuit obtains a plurality of candidate cryptographic keys based on the biometric data objects that most closely match the biometric parameters from the user. At 1108, the processing circuit applies one or more of the plurality of candidate cryptographic keys in an attempt to access information secured with a valid cryptographic key of the user.

FIG. 12 broadly illustrates and summarizes further methods or procedures 1200 that may be performed by processing circuit 804 of FIG. 8 or other suitably equipped devices for biometric decryption and/or user authentication. At 1202, the processing circuit obtains a plurality of different biometric input parameters from the user including one or more of skinprint parameters (such as fingerprints, thumbprints and knuckle prints), iris scan parameters (corresponding to different sections or quadrants of the iris of both eyes) and/or voice recognition parameters (corresponding to a plurality of spoken words.) At 1204, the processing circuit compares the biometric parameters to biometric templates in the data object database to identify the closest matches wherein the database includes several authentic biometric templates for the user and a substantially greater number of synthetic templates (e.g. at least a million) not associated with the user, wherein the biometric templates are each associated with an offset corresponding to a point on a multidimensional curve using modular arithmetic and wherein a predetermined number of offsets are required to uniquely specify a particular multidimensional curve.

At 1206, the processing circuit obtains a plurality of candidate cryptographic key components by deriving each individual candidate cryptographic key component from a particular multidimensional curve (specified by a combination of offsets corresponding to at least some of the plurality of the identified biometric data objects) by identifying a point of intersection of the particular multidimensional curve with a y-axis (or other axis or surface), the point of intersection providing an identifier to a cryptographic key component. At 1208, the processing circuits authenticates the user by sequentially applying the candidate cryptographic key components to access a secure system programmed with a valid cryptographic key component of the user until one of the candidate cryptographic key components gains access and, if at least one of the candidate cryptographic components gains access, the user is thereby authenticated and, if none of the candidate cryptographic components gains access, the user is thereby not authenticated. At 1208, each cryptographic key component is one or more of a symmetric cryptographic key, a private cryptographic key of an asymmetric private key/public key pair and/or a cryptographic seed used to initialize a pseudo-random generator from which a symmetric key or private key is generated.

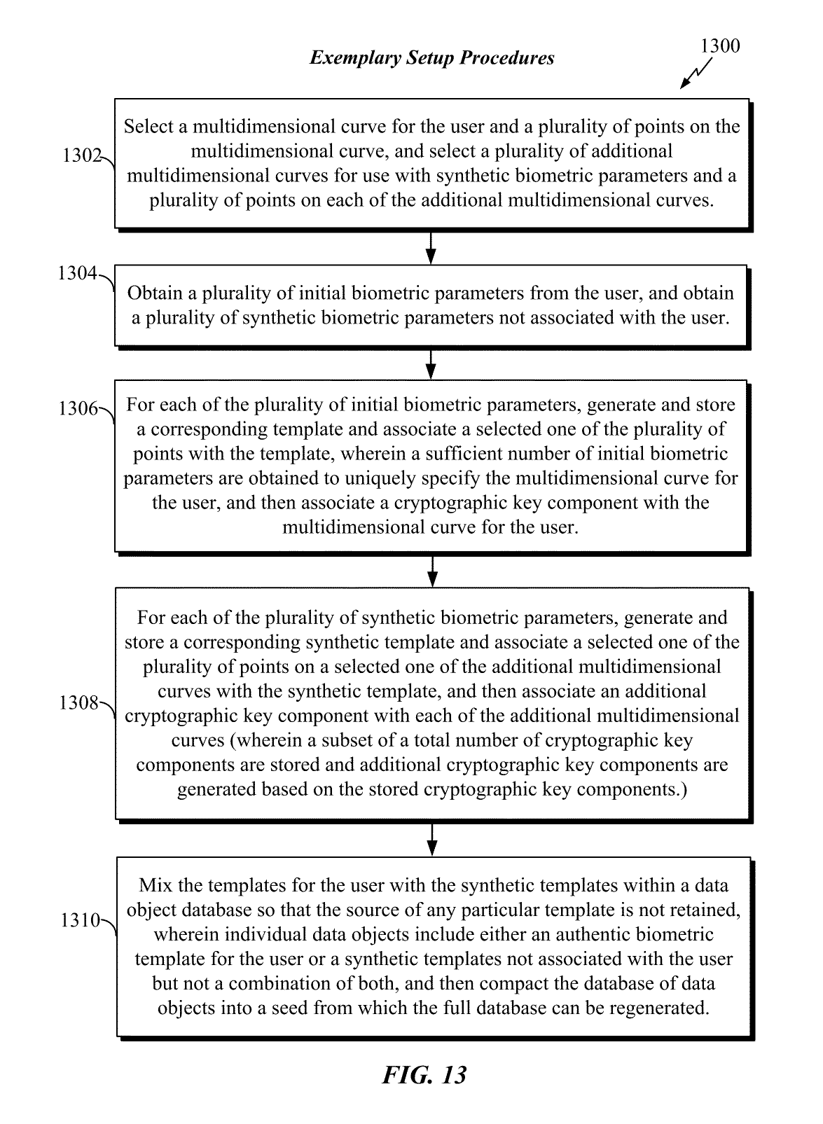

FIG. 13 broadly illustrates and summarizes exemplary methods or procedures 1200 that may be performed by processing circuit 804 of FIG. 8 or other suitably equipped devices for setting up a system for biometric decryption and/or authentication. At 1302, the processing circuit selects a multidimensional curve for the user and a plurality of points on the multidimensional curve, and selects a plurality of additional multidimensional curves for use with synthetic biometric parameters and a plurality of points on each of the additional multidimensional curves. At 1304, the processing circuit obtains a plurality of initial biometric parameters from the user and obtains a plurality of synthetic biometric parameters not associated with the user. At 1306, for each of the plurality of initial biometric parameters, the processing circuit generates and stores a corresponding template and associates a selected one of the plurality of points with the template, wherein a sufficient number of initial biometric parameters are obtained to uniquely specify the multidimensional curve for the user, and then the processing circuit also associates a cryptographic key component with the multidimensional curve for the user.

At 1308, for each of the plurality of synthetic biometric parameters, the processing circuit generates and stores a corresponding synthetic template and associates a selected one of the plurality of points on a selected one of the additional multidimensional curves with the synthetic template, At 1308, the processing circuit also associates an additional cryptographic key component with each of the additional multidimensional curves (wherein a subset of a total number of cryptographic key components are stored and additional cryptographic key components are generated based on the stored cryptographic key components.) At 1310, the processing circuit mixes the templates for the user with the synthetic templates within a data object database so that the source of any particular template is not retained, wherein individual data objects include either an authentic biometric template for the user or a synthetic template not associated with the user but not a combination of both. At 1310, the processing circuit also compacts the database of data objects into a seed from which the full database can be regenerated.

It is noted that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

It is contemplated that various features described herein may be implemented in different systems. It should be noted that the foregoing aspects of the disclosure are merely examples and are not to be construed as limiting. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A method for biometric processing, comprising:
obtaining biometric parameters from a user;
comparing the biometric parameters to a database of biometric data objects to identify biometric data objects that most closely match the biometric parameters from the user, wherein the database includes at least one authentic biometric data object for the user and a larger number of synthetic biometric data objects not associated with the user;
obtaining a plurality of candidate cryptographic keys based on the biometric data objects that most closely match the biometric parameters from the user; and
applying one or more of the plurality of candidate cryptographic keys in an attempt to access information secured with a valid cryptographic key of the user.

2. The method of claim 1, wherein applying one or more of the plurality of candidate cryptographic keys in an attempt to access information includes authenticating the user by identifying a candidate key that successfully accesses a system secured by the valid cryptographic key of the user.

3. The method of claim 1, wherein applying one or more of the plurality of candidate cryptographic keys in an attempt to access information includes decrypting information previously encrypted by the valid cryptographic key of the user.

4. The method of claim 1, wherein the biometric parameters correspond to a plurality of different biometric parameters from the user including one or more skinprint parameters, iris scan parameters and voice recognition parameters.

5. The method of claim 4, wherein the skinprint parameters include one or more fingerprints, thumbprints and knuckle prints.

6. The method of claim 4, wherein the iris scan parameters correspond to different portions of the iris of at least one eye of the user.

7. The method of claim 1, wherein the database includes at least one authentic biometric data object for each of a plurality of different biometric parameters of the user and a larger number of synthetic biometric data objects not associated with the user.

8. The method of claim 7, wherein the larger number of synthetic biometric data objects not associated with the user includes at least a million synthetic biometric data objects.

9. The method of claim 1, wherein the biometric data objects are each associated with an offset corresponding to a point on a multidimensional curve using modular arithmetic and wherein a predetermined number of offsets are required to uniquely specify the multidimensional curve.

10. The method of claim 9, wherein obtaining a particular cryptographic key of the plurality of candidate cryptographic keys includes deriving a cryptographic key component from a corresponding multidimensional curve specified by the offsets corresponding to some of the plurality of the identified biometric data objects.

11. The method of claim 10, wherein deriving the corresponding cryptographic key component from the corresponding multidimensional curve includes identifying a point of intersection of the corresponding multidimensional curve with a predetermined axis.

12. The method of claim 1, wherein comparing the biometric parameters to a database of biometric data objects to identify biometric data objects that most closely match the biometric parameters from the user includes identifying ten or fewer biometric data objects for each biometric parameter from a database of at least a million biometric data objects.

13. The method of claim 1, wherein applying one or more of the plurality of candidate cryptographic keys in an attempt to access information secured with a valid cryptographic key of the user comprises authenticating the user by:
applying the candidate cryptographic keys to a secure system programmed with the valid cryptographic key until one of the candidate cryptographic keys accesses the secure system and the user is thereby authenticated and, if none of the candidate cryptographic keys accesses the secure system, the user is thereby not authenticated.

14. The method of claim 1, wherein the cryptographic key is one or more of a symmetric cryptographic key, a private cryptographic key of an asymmetric private key/public key pair, or a cryptographic seed used to initialize a pseudo-random generator from which a key is generated.

15. The method of claim 1, further including a setup procedure for generating the database that includes the at least one authentic biometric data object for the user and the larger number of synthetic biometric data objects not associated with the user.

16. The method of claim 15, wherein the setup procedure comprises:
selecting a multidimensional curve for the user and selecting a plurality of points on the multidimensional curve;
obtaining a plurality of initial biometric parameters from the user;
for each of the plurality of initial biometric parameters, generating and storing a corresponding biometric template and associating a selected one of the plurality of points with the biometric template wherein a sufficient number of initial biometric parameters are obtained to uniquely specify the multidimensional curve for the user; and
associating a cryptographic key component with the multidimensional curve for the user.

17. The method of claim 16, wherein the setup procedure further comprises:
selecting a plurality of additional multidimensional curves for use with synthetic biometric parameters and selecting a plurality of points on each of the additional multidimensional curves;
obtaining a plurality of synthetic biometric parameters not associated with the user;
for each of the plurality of synthetic biometric parameters, generating and storing a corresponding synthetic biometric template in the database and associating a selected one of the plurality of points on a selected one of the additional multidimensional curves with the synthetic biometric template; and
associating an additional cryptographic key component with each of the additional multidimensional curves.

18. The method of claim 17, further comprising mixing the biometric templates for the user with the synthetic biometric templates within the database so that the source of any particular template is obscured.

19. The method of claim 17, further comprising compacting the database of biometric objects into a seed from which the full database can be regenerated.

20. The method of claim 17, wherein individual biometric data objects in the database include either an authentic biometric data object for the user or a synthetic biometric data object not associated with the user but not a combination of both.

21. The method of claim 17, wherein a subset of a total number of cryptographic key components is stored and additional cryptographic key components are generated based on the stored cryptographic key components.

22. A device, comprising:
a biometric parameter detector operative to obtain at least one biometric parameter from a user;
a storage device; and
a processing circuit operative to
obtain biometric parameters from the user using the biometric parameter detector;
compare the biometric parameters to a database of biometric data objects stored in the storage device to identify biometric data objects that most closely match the biometric parameters from the user, wherein the database includes at least one authentic biometric data object for the user and a larger number of synthetic biometric data objects not associated with the user;
obtain a plurality of candidate cryptographic keys based on the biometric data objects that most closely match the biometric parameters from the user; and
apply one or more of the plurality of candidate cryptographic keys in an attempt to access information secured with a valid cryptographic key of the user.

23. The device of claim 22, wherein the processing circuit is further operative to authenticate the user by identifying a candidate key that successfully accesses a system secured by the valid cryptographic key of the user.

24. The device of claim 22, wherein the processing circuit is further operative to decrypt information previously encrypted by the valid cryptographic key of the user.

25. A device, comprising:
means for obtaining biometric parameters from the user;
means for comparing the biometric parameters to a database of biometric data objects to identify biometric data objects that most closely match the biometric parameters from the user, wherein the database includes at least one authentic biometric data object for the user and a larger number of synthetic biometric data objects not associated with the user;
means for obtaining a plurality of candidate cryptographic keys based on the biometric data objects that most closely match the biometric parameters from the user; and
means for applying one or more of the plurality of candidate cryptographic keys in an attempt to access information secured with a valid cryptographic key of the user.

26. The device of claim 25, wherein the means for applying one or more of the plurality of candidate cryptographic keys in an attempt to access information secured with a valid cryptographic key of the user includes means for authenticating the user by identifying a candidate key that successfully accesses a system secured by the valid cryptographic key of the user.

27. The device of claim 25, wherein the means for applying one or more of the plurality of candidate cryptographic keys in an attempt to access information secured with a valid cryptographic key of the user includes means for decrypting information previously encrypted by the valid cryptographic key of the user.

28. A machine-readable storage medium for biometric processing, the machine-readable storage medium having one or more instructions which when executed by at least one processing circuit causes the at least one processing circuit to:
obtain biometric parameters from the user;
compare the biometric parameters to a database of biometric data objects to identify biometric data objects that most closely match the biometric parameters from the user, wherein the database includes at least one authentic biometric data object for the user and a larger number of synthetic biometric data objects not associated with the user;
obtain a plurality of candidate cryptographic keys based on the biometric data objects that most closely match the biometric parameters from the user; and
apply one or more of the plurality of candidate cryptographic keys in an attempt to access information secured with a valid cryptographic key of the user.

29. The machine-readable storage medium of claim 28, further comprising instructions for authenticating the user by identifying a candidate key that successfully accesses a system secured by the valid cryptographic key of the user.

30. The machine-readable storage medium of claim 28, further comprising instructions for decrypting information previously encrypted by the valid cryptographic key of the user.
